(19) United States
(12) Patent Application Publication
(10) Pub. No.: US 2024/0273573 A1
(43) Pub. Date: Aug. 15, 2024

(54) SELECTION OF CONTENT FOR INSERTION IN VIDEOS

(71) Applicant: HULU, LLC, Santa Monica, CA (US)

(72) Inventors: Dingming WU, Beijing (CN); Chunyang WEI, Beijing (CN)

(73) Assignee: HULU, LLC, Santa Monica, CA (US)

(21) Appl. No.: 18/644,058

(22) Filed: Apr. 23, 2024

Related U.S. Application Data
(63) Continuation of application No. 16/698,464, filed on Nov. 27, 2019.

(51) Int. Cl. G06Q 30/0251; G06Q 30/0241; G06Q 30/0273

(52) U.S. Cl. CPC G06Q 30/0251; G06Q 30/0247; G06Q 30/0273

(57) ABSTRACT

In some embodiments, an apparatus includes storage for storing a first parameter that controls selection between guaranteed deals and non-guaranteed deals and a second parameter that controls selection between guaranteed deals, and not with the non-guaranteed deals. A controller uses feedback from selection of secondary content that is associated with guaranteed deals being delivered to individually update the first parameter or the second parameter for guaranteed deals based on a delivery number and a delivery speed of a guaranteed deal compared to an expected delivery pattern. A selector selects a guaranteed deal based on the second parameter for guaranteed deals; compares a first value that represents respective values of the first parameter and a second value that represents respective values of the first parameter to select one of the group of guaranteed deals or the group of non-guaranteed deals; and selects secondary content for delivery during primary content.

### CROSS REFERENCE TO RELATED APPLICATIONS

This application is a continuation application and, pursuant to 35 U.S.C. § 120, is entitled to and claims the benefit of earlier filed application U.S. application Ser. No. 16/698,464, filed Nov. 27, 2019, the content of which is incorporated herein by reference in its entirety for all purposes.

### BACKGROUND

An ad delivery system selects advertisements to deliver to client devices, such as during advertising breaks while a client device is playing a video offered by a video delivery service. The ad delivery system may attempt to match advertisement deals to advertisement inventory aiming to fully deliver the advertisement deals and optimize advertisement revenue for the video delivery service. The advertisement deals may be associated with different prices that result in revenue on delivering respective advertisements.

The video delivery service may include a process that selects the advertisement deals for delivery to the client device. In some cases, advertisement deals include a goal that guarantees a certain amount of advertisement deliveries in a time period with a certain pacing. For example, the pacing may define how often the advertisement should be delivered to client devices over a period of time. In some cases, it may be challenging for the process to guarantee that an advertisement deal with a small goal can be delivered in an even pacing manner. For example, an advertisement deal with a small goal may be over-delivered in a short amount of time after being offered if that advertisement deal is associated with a high price.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts a simplified system for selecting advertisements to deliver according to some embodiments.

FIG. 2 depicts an example of guaranteed deals and non-guaranteed deals according to some embodiments.

FIG. 3 depicts a simplified flowchart of a method for selecting advertisements from guaranteed deals or non-guaranteed deals according to some embodiments.

FIG. 4 depicts a video streaming system in communication with multiple client devices via one or more communication networks according to one embodiment.

FIG. 5 depicts a diagrammatic view of an apparatus for viewing video content and advertisements.

### DETAILED DESCRIPTION

Described herein are techniques for an advertisement delivery system. In the following description, for purposes of explanation, numerous examples and specific details are set forth in order to provide a thorough understanding of some embodiments. Some embodiments as defined by the claims may include some or all of the features in these examples alone or in combination with other features described below and may further include modifications and equivalents of the features and concepts described herein.

An advertisement (ad) delivery system may select from different types of advertisement deals for a service, such as a video delivery service. A first type of advertisement deal may be referred to as a guaranteed deal whose goals and prices are determined by negotiation. For example, the service may guarantee to fully deliver the guaranteed deal based on the goals in a pre-defined time. The revenue received from the delivery is agreed upon based on the price associated with the guaranteed deal. In some embodiments, an advertiser prefers that the guaranteed deals are delivered based on a pacing, such as in an even pacing manner over the pre-defined time. That is, the service should not deliver all of the advertisements in the goal in the first couple hours in the pre-defined time, but rather evenly space the delivery of the advertisements over the pre-defined time. A second type of advertisement deal is a non-guaranteed deal where the service does not guarantee delivery of the advertisements as to the amount of advertisements delivered or the pacing. Rather, the service may charge advertisers based on how many advertisements are delivered (e.g., impressions). The revenue received for the non-guaranteed deals may be based on a price that may be negotiated by the service and the advertiser based on offline negotiation or by online bidding.

As discussed above, some guaranteed deals with a small goal and a pacing requirement (e.g., an even pacing requirement) may be hard to deliver as required. For example, if an ad selector selects a highest ranked guaranteed deal from a qualified pool of advertisements of guaranteed deals, an advertisement deal with a maximum price may be continually selected. This may cause the selected advertisement to be over-delivered, which may affect the even pacing requirement. To overcome this problem, an ad selector may select a guaranteed deal using a function that may not select a guaranteed deal that has an associated maximum price, but rather may use a weighted random method. Then, the ad selector may determine an opportunity cost based on a set of guaranteed deals in a qualification pool of guaranteed deals that are eligible to be selected. The set of guaranteed deals may be a portion of or the whole qualification pool. Then, the ad selector compares the opportunity cost to non-guaranteed deals. The ad selector then selects the advertisement deal based on the opportunity cost comparison, such as if the opportunity cost for the guaranteed deal is higher than the opportunity cost for a non-guaranteed deal, then the ad selector selects the guaranteed deal that was originally selected. However, the ad selector selects the non-guaranteed deal if the opportunity cost for the non-guaranteed deal is higher.

By selecting a guaranteed deal in a weighted random method and also determining the opportunity cost based on a set of guaranteed deals in the qualification pool, the ad selector may select advertisements for delivery more efficiently based on the requirements of the guaranteed deals. For example, a guaranteed deal with a small goal and an even pacing requirement may not be over-delivered in a short time period because the guaranteed deal may not always be selected if it has the highest price in the guaranteed deals or the greatest opportunity cost.

### System Overview

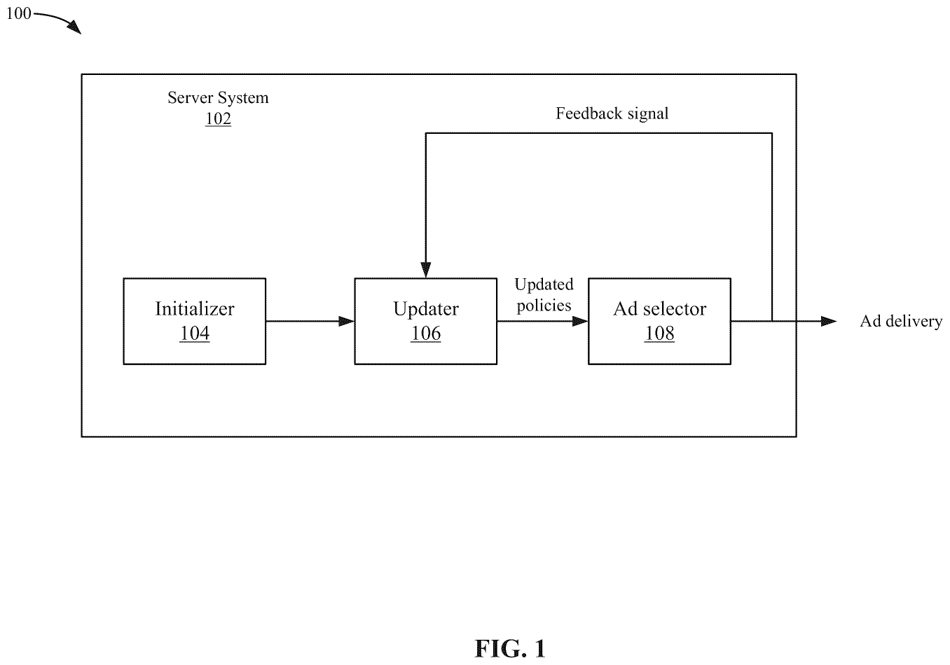

FIG. 1 depicts a simplified system 100 for selecting advertisements to deliver according to some embodiments. A server system 102 may select advertisements for delivery to client devices (not shown). Server system 102 includes an initializer 104, an updater 106, and an ad selector 108. In some embodiments, the advertisements may be delivered during advertising breaks during videos that are being played by the video delivery service. However, although a video is described, the advertisements may be displayed for other content, such as on webpages or other applications and interfaces.

An initializer 104 initializes parameters for advertisement deals. For example, initializer 104 may initialize a policy that is used by server system 102 to select advertisements for advertisement deals. An advertisement deal may be associated with an advertisement that is delivered to client devices and include parameters that govern the delivery of the advertisement and are used to select the deal. In some embodiments, a policy includes one or more parameters, such as a probabilistic coefficient and a marginal revenue. The advertisement deals may be organized into groups, such as guaranteed deals and non-guaranteed deals.

A probabilistic coefficient may be initialized and then updated based on the pacing requirement for an associated guaranteed deal. The pacing requirement may be a value expressed as a number of advertisements delivered over a set time. For example, the probabilistic coefficient may be adjusted to be higher when the pacing status is under pacing (e.g., behind the pacing requirements) the pacing requirements or adjusted to be lower when the pacing status is over pacing (e.g., ahead of the pacing requirements) the pacing requirements. The marginal revenue may be based on a revenue value or price. Marginal revenue for a guaranteed deal may be updated on the pacing requirements and the current pacing status for a respective guaranteed deal. For example, marginal revenue may be adjusted to be higher when the pacing status is under pacing the pacing requirements or adjusted to be lower when the pacing status is over pacing the pacing requirements. The marginal revenue for non-guaranteed deals may be based on a price factor, such as the cost per mille (CPM). The cost per mille may be the price of 1,000 advertisement impressions. The price factor describes how much revenue the service receives when an advertisement for a non-guaranteed deal is delivered. The marginal revenue for a non-guaranteed deal may not change during time the non-guaranteed deal is active because there are no pacing requirements for the non-guaranteed deal and the price remains constant. If the price changes during the time period, the marginal revenue for the non-guaranteed deal may change, however. Accordingly, the marginal revenue for a non-guaranteed deal is determined differently from the marginal revenue for guaranteed deals.

The pricing coefficient and marginal revenue may be both based on pacing requirements. However, the pricing coefficient and marginal revenue may be different in some respects. For example, the pricing coefficient and marginal revenue differ in scale. The probabilistic coefficient may be a probability, which may be between a range, such as between 0 and 1. Marginal revenue may be a price used to compare to non-guaranteed deals. The price may be between another range, such as between $10 (CPM) and $60 (CPM). Also, the pricing coefficient and marginal revenue are used differently. Marginal revenue controls the competition between guaranteed deals and non-guaranteed deals. The pacing coefficient controls the competition within only guaranteed deals and does not involve non-guaranteed deals.

Accordingly, for guaranteed deals, the policy may include the two parameters of the probabilistic coefficient and the marginal revenue. For non-guaranteed deals, only one of the parameters is used. Thus, the guaranteed deals and non-guaranteed deals use different parameters and also the marginal revenue is determined differently.

As discussed above, updater 106 adjusts the policies for guaranteed deals that are active according to the delivery of guaranteed deals compared to pacing requirements. For example, updater 106 may receive a feedback signal from the selection of advertisements to be delivered from ad selector 108. Updater 106 may then adjust the policy for that guaranteed deal. In some embodiments, updater 106 may decrease the probabilistic coefficient and/or the marginal revenue when the delivery is ahead of the pacing requirement. Otherwise, updater 106 may increase the probabilistic coefficient and/or the marginal revenue when the delivery of the advertisements for the advertisement deal is behind the pacing requirement. The adjustment may affect the future pacing of the delivery of the advertisements for the guaranteed deal.

Ad selector 108 receives the updated policies and can select advertisements to deliver. For example, when ad selector 108 receives a signal that an advertisement should be selected for delivery to a client device, ad selector 108 selects an advertisement from a guaranteed deal or non-guaranteed deal based on the policies. The selection will be described in more detail below. Once ad selector 108 selects an advertisement, the advertisement may be delivered to a client device (not shown). For example, when a client device is playing a video, an advertisement selected by ad selector 108 may be played during an advertisement break. In other embodiments, when a user views a page in an application, ad selector 108 may select an advertisement to display in the page on the client device.

### Guaranteed and Non-Guaranteed Deal Examples

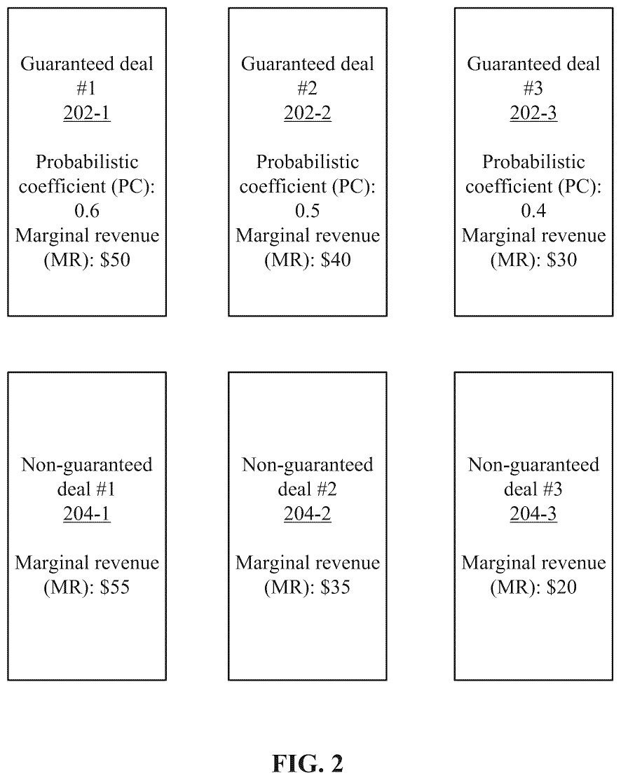

FIG. 2 depicts an example of guaranteed deals and non-guaranteed deals according to some embodiments. Although these examples are shown, it will be understood that other examples may be appreciated.

Guaranteed deals #1 to #3 202-1 to 202-3 are associated with parameter values of probabilistic coefficient (PC) values and parameter values of marginal revenue (MR) values. Non-guaranteed deals #1 to #3 204-1 to 204-3 are associated with parameter values of marginal revenue values. Accordingly, non-guaranteed deals 204 are not associated with probabilistic coefficients. One reason why non-guaranteed deals 204 are not associated with probabilistic coefficients is that probabilistic deals are not associated with any pacing requirements. For example, guaranteed deal #1 may include a probabilistic coefficient value of 0.6 and a marginal revenue value of $50 and guaranteed deal #2 may include a probabilistic coefficient value of 0.5 and a marginal revenue value of $40. Because the probabilistic coefficient and/or the marginal revenue value of guaranteed deal #2 is lower than the probabilistic coefficient value and/or marginal revenue value of guaranteed deal #1, it may be less likely that ad selector 108 may select guaranteed deal #2.

Non-guaranteed deal #1 may have a marginal revenue value of $55 and non-guaranteed deal #2 may have a marginal revenue value of $35. Because non-guaranteed deal #2 has a lower marginal revenue value than non-guaranteed deal #1, it may be less likely that ad selector 108 selects non-guaranteed deal #2 over non-guaranteed deal #1. The lower marginal revenue value for non-guaranteed deal #2 may indicate that the price or revenue received for delivering non-guaranteed deal #2 is less than the price or marginal revenue received for non-guaranteed deal #1.

In one example, initializer 104 may initialize probabilistic coefficients to a value, such as 0.01. The probabilistic coefficient may be based on a fixed initial value or based on the pacing requirements for a respective guaranteed deal. Initializer 104 may initialize marginal revenue to a value based on marginal revenue values for non-guaranteed deals, such as an average bidding price of non-guaranteed deals. The average bidding price for non-guaranteed deals may be used because the marginal revenue will be used to finally select between the category of the non-guaranteed deal and the guaranteed deal as will be discussed below. By starting the marginal revenue for non-guaranteed deals at the average bidding price, the marginal revenue for guaranteed deals will not be significantly higher or lower than the non-guaranteed deals. However, updater 106 may update the values for the probabilistic coefficients and marginal revenue values based on feedback from delivery of advertisements from the guaranteed deals.

Updater 106 may adjust the probabilistic coefficient values and marginal revenue values based on different factors. For example, updater 106 may use an absolute delivered number of advertisements (e.g., an impression value) and the delivery speed. Updater 106 may set an expected delivery pattern (e.g., pacing requirement) for an advertisement deal and then calculate the absolute delivery speed from the expected delivery pattern. The absolute delivery may mean the number of times an advertisement is delivered. The delivery speed may be the speed at which the advertisement is delivered over time. When updater 106 compares the actual delivery to the expected delivery, updater 106 may determine whether the guaranteed deals have been delivered too much or too fast during a time period. If so, updater 106 may decrease one or more of the probabilistic coefficient values or the marginal revenue value for the guaranteed deal. In some embodiments, updater 106 independently adjust a policy for each advertisement deal using a controller. The probabilistic coefficient values and the marginal revenue value may be adjusted differently based on pacing or using the same method. If a guaranteed deal is delivered in a time period (e.g., a time unit is day) t∈[0, T], with goal G, an even pacing curve is E(t)=G/Tt, the actual delivery is A(t). The probabilistic coefficient and the marginal revenue are c(t), r(t) respectively. Updater 106 adjusts the probabilistic coefficient and the marginal revenue in a time period δt. Then, updater 106 may use the following, but other adjustments may be used:

$$ln c ( t ) = ln c ( t - δ t ) - 16 T {π}^{2} ( \frac{A ( t )}{G} - \frac{t}{T} ) δ t - 8 T π ( \frac{A ( t ) - A ( t - δ t )}{G} - \frac{δ t}{T} )$$

$$ln r ( t ) = ln r ( t - δ t ) - 16 T {π}^{2} ( \frac{A ( t )}{G} - \frac{t}{T} ) δ t - 8 T π ( \frac{A ( t ) - A ( t - δ t )}{G} - \frac{δ t}{T} )$$

### Ad Selection

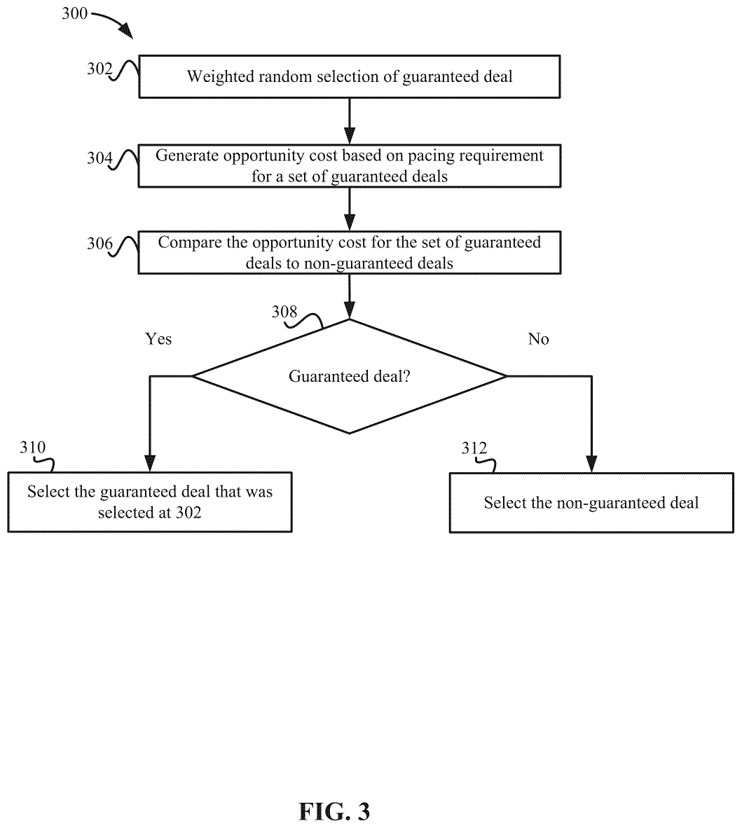

FIG. 3 depicts a simplified flowchart 300 of a method for selecting advertisements from guaranteed deals or non-guaranteed deals according to some embodiments. Ad selector 108 may receive a set of candidate deals and can select one of the advertisement deals. For example, ad selector 108 receives eligible deals for an advertising break and selects one of the advertising deals for delivery during the advertising break.

At 302, ad selector 108 performs a selection of a guaranteed deal using a function. For example, the function may be a weighted random selection function that can randomly select a guaranteed deal from the eligible guaranteed deals. The random selection may be weighted based on the probabilistic coefficient values of the guaranteed deals. That is, if a guaranteed deal has a higher probabilistic coefficient value than a second guaranteed deal, the first guaranteed deal may have a higher chance of being selected. However, ad selector 108 performs a random selection of one of the guaranteed deals and does not select the guaranteed deal with the highest probabilistic coefficient. In some embodiments, the selected deal may be an empty deal with a probabilistic coefficient where all the guaranteed deals are very small. An empty deal may be where no advertisement is selected.

At 304, ad selector 108 generates an opportunity cost based on a pacing requirement for a set of guaranteed deals. The set of guaranteed deals may be all the eligible guaranteed deals that were received by ad selector 108 or a portion of them. Ad selector 108 may calculate the opportunity cost using different methods. The opportunity cost may be a measurement that represents the cost if the advertisement deal is not selected. In calculating the opportunity cost, an auction may be used in some embodiments. Each guaranteed deal bids with its marginal revenue and the winning price is the maximum marginal revenue of all guaranteed deals. And ad selector 108 compares the winning guaranteed deal with the winning non-guaranteed deal and determines which one has the higher bid and wins the auction. If ad selector 108 only considered the guaranteed deals, the opportunity cost should be the winning deal among them, which is the maximum marginal revenue among them. In some embodiments, ad selector 108 may determine a pacing risk for the guaranteed deals. For example, if ad selector 108 determines that there is a risk of under-pacing (not delivering enough advertisements for the guaranteed deal over time), then ad selector 108 may set the opportunity cost as a high value, such as at infinity. In some embodiments, ad selector 108 calculates the opportunity cost based on the probabilistic coefficients of the qualified guaranteed deals. For example, ad selector 108 calculates the sum of probabilistic coefficient values of all the qualified guaranteed deals, but methods other than a sum may be used. The probabilistic coefficients may be used because the values have been updated based on pacing requirements and reflect the pacing status of the guaranteed deals, such as whether guaranteed deals are over pacing or under pacing their goals. If the sum is larger than a threshold, such as a value of “1”, then this means the guaranteed deals are at risk of under-pacing and ad selector 108 sets the opportunity cost as a high value, such as infinity. If the sum of the probabilistic coefficients is less than a threshold, such as a value of “1”, this means the guaranteed deals are not at risk of under-pacing (e.g., they may be over-pacing the pacing requirements). Ad selector 108 may then set the opportunity cost as another value that may be less than the high value set when the sum was above the value of “1”. For example, ad selector 108 sets the opportunity cost as the maximum marginal revenue found in the qualified guaranteed deals. That is, ad selector 108 may determine the highest marginal revenue found in all the qualified guaranteed deals. Because the probabilistic coefficients are based on pacing, ad selector 108 can use the probabilistic coefficients to determine whether or not the guaranteed deals as a whole are under-pacing or over-pacing a pacing requirement.

At 306, ad selector 108 compares the opportunity cost for the set of guaranteed deals to the opportunity costs for the non-guaranteed deals. Ad selector 108 may compare the opportunity cost for the guaranteed deals to each of the marginal revenue values of the non-guaranteed deals. In some embodiments, each non-guaranteed deal may have a value associated with its opportunity cost, such as a value associated with its associated marginal revenue. In other embodiments, ad selector 108 may determine the maximum marginal revenue value for the non-guaranteed deals and compare that value to the opportunity cost of the guaranteed deals. Because the marginal revenue for the guaranteed deals were set based on the marginal revenue of the non-guaranteed deals, the comparison may be used to determine whether or not the guaranteed deals as a whole are under pacing or over pacing. For example, if the guaranteed deals are under pacing requirements, then updater 106 may have increased the marginal revenue for the guaranteed deals, which increases the opportunity cost for the guaranteed deals. This makes it more likely the guaranteed deals have a higher opportunity cost. The reverse is true if the guaranteed deals are over pacing the requirements.

Based on the comparison, ad selector 108 selects either category of the guaranteed deals or the non-guaranteed deals. At 308, ad selector 108 determines if the category of the guaranteed deal is selected. If the category of the guaranteed deal is selected, at 310, ad selector 108 selects the guaranteed deal that was selected at 302. If the category of the guaranteed deal is not selected, at 312, ad selector 108 selects a non-guaranteed deal. In some embodiments, the non-guaranteed deal is the deal with the highest marginal revenue among the non-guaranteed deals, but other non-guaranteed deals may be selected.

Accordingly, ad selector 108 did not select a guaranteed deal outright that has the highest probabilistic coefficient and/or marginal revenue. Rather, ad selector 108 used a weighted random selection. Also, ad selector 108 determines the opportunity cost based on all the qualified guaranteed deals and not just a single selected guaranteed deal. However, if the category of the guaranteed deal is selected, ad selector 108 selects a guaranteed deal at random. By using the above process, ad selector 108 may overcome the possibility of over-delivering or under-delivering a guaranteed deal with a small goal compared to other advertising deals. This is because the weighted random selection is used to select a guaranteed deal and also the opportunity costs for all guaranteed deals are considered when selecting between a guaranteed deal and a non-guaranteed deal. The weighted random selection may ensure that the guaranteed deal with the highest probabilistic coefficient and/or marginal revenue is not always selected. For example, if a guaranteed deal with a small goal has a large probabilistic coefficient or marginal revenue, ad selector 108 may not always select that guaranteed deal because the weighted random selection is being used. Also, by using the opportunity costs for all guaranteed deals, ad selector 108 may not always select a non-guaranteed deal that has a higher price over the guaranteed deals.

### Ad Delivery

Once the guaranteed deal or the non-guaranteed deal is selected, server system 102 may deliver a selected advertisement from the guaranteed deal or the non-guaranteed deal. This results in a delivery of an advertisement for the guaranteed deal or non-guaranteed deal. The client device may then display the advertisement on an interface, such as during an advertisement break in a video.

### Conclusion

ACCORDINGLY, some embodiments select an advertisement from guaranteed deals and non-guaranteed deals in a manner that may more efficiently select advertisements from guaranteed deals and non-guaranteed deals. For example, guaranteed deals with smaller goals and an even-pacing requirement may be more optimally delivered based on ad selector 108 selecting the advertisements as described above. The above process may avoid selecting guaranteed deals with high negotiated prices or non-guaranteed deals with high negotiated prices in an uneven pacing.

### Example Embodiments

In some embodiments, a method comprising: receiving, by a computing device, a request for an advertisement during delivery of content to a client device; selecting, by the computing device, a first advertisement deal from a first grouping of advertisement deals based on a first parameter value for the first advertisement deal; determining, by the computing device, a second parameter value for advertisement deals in the first grouping of advertisement deals; comparing, by the computing device, the second parameter value of the advertisement deals in the first grouping of advertisement deals to a second parameter value of a set of second advertisement deals from a second grouping of advertisement deals; selecting, by the computing device, one of a first category of the first grouping of advertisement deals and a second category of the second grouping of advertisement deals; and selecting, by the computing device for the request, a first advertisement deal from the first grouping of advertisement deals when the first category of the first grouping of advertisement deals is selected and a second advertisement deal when the second category of the second grouping of advertisement deals is selected.

In some embodiments, the first grouping of advertisement deals comprises guaranteed advertisement deals.

In some embodiments, guaranteed advertisement deals are associated with a set price based on being delivered to the client device.

In some embodiments, guaranteed advertisement deals are associated with a set pacing of delivering an associated guaranteed advertisement deal over a time period.

In some embodiments, guaranteed advertisement deals are associated with a guaranteed number of advertisement deals that are delivered to client devices over a time period.

In some embodiments, the second grouping of advertisement deals comprises non-guaranteed advertisement deals.

In some embodiments, non-guaranteed advertisement deals are not associated with a set pacing of delivery or a guaranteed number of advertisement deals that are delivered to client devices over a time period.

In some embodiments, selecting the first advertisement deal from the first grouping of advertisement deals based on the first parameter value for the first advertisement deal comprises: randomly selecting the first advertisement deal from the first grouping of advertisement deals.

In some embodiments, selecting the first advertisement deal from the first grouping of advertisement deals based on the first parameter comprises: using a weighted function to randomly select the first advertisement deal from the first grouping of advertisement deals, wherein the weighted function is based on first parameter values for the advertisement deals in the first grouping of advertisement deals.

In some embodiments, determining the second parameter value using the second parameter for advertisement deals in the first grouping of advertisement deals comprises: adjusting the second parameter value based on a pacing requirement for respective advertisement deals in the first grouping of advertisement deals, wherein the pacing requirement specifies a frequency of delivery of the advertisement deals in the first grouping of advertisement deals over time.

In some embodiments, the second parameter value is adjusted based on an evaluation of a pacing requirement and actual delivery of advertisements for each of the advertisement deals in the first grouping of advertisement deals.

In some embodiments, the second parameter value for the first grouping of advertisement deals is set as a maximum value from second parameter values associated with advertisement deals in the first grouping of advertisement deals.

In some embodiments, the second parameter value is set as a value to ensure that an advertisement deal in the first grouping of advertisement deals is selected to send to the client device.

In some embodiments, the second parameter value for the second grouping of advertisement deals is based on a price received for delivery of an advertisement in respective advertisement deals.

In some embodiments, the first parameter value for the first grouping of advertisement deals is set to an initial value, and the second parameter value for the first grouping of advertisement deals is set based on second parameter values in the second grouping of advertisement deals.

In some embodiments, the first parameter value and the second parameter value for the first grouping of advertisements are adjusted based on a pacing status of respective advertisement deals, the pacing status based on delivery of advertisements in a respective advertisement deal in the first grouping of advertisements.

In some embodiments, selecting one of the first category of the first grouping of advertisement deals and the second category of the second grouping of advertisement deals comprises: selecting one of the first category of the first grouping of advertisement deals and the second category of the second grouping of advertisement deals based on a highest second parameter value for the first grouping of advertisement deals and the second grouping of advertisement deals.

In some embodiments, a non-transitory computer-readable storage medium containing instructions, that when executed, control a computer system to be operable for: receiving a request for an advertisement during delivery of content to a client device; selecting a first advertisement deal from a first grouping of advertisement deals based on a first parameter value for the first advertisement deal; determining a second parameter value for advertisement deals in the first grouping of advertisement deals; comparing the second parameter value of the advertisement deals in the first grouping of advertisement deals to a second parameter value of a set of second advertisement deals from a second grouping of advertisement deals; selecting one of a first category of the first grouping of advertisement deals and a second category of the second grouping of advertisement deals; and selecting, for the request, a first advertisement deal from the first grouping of advertisement deals when the first category of the first grouping of advertisement deals is selected and a second advertisement deal when the second category of the second grouping of advertisement deals is selected.

In some embodiments, selecting the first advertisement deal from the first grouping of advertisement deals based on the first parameter value for the first advertisement deal comprises: randomly selecting the first advertisement deal from the first grouping of advertisement deals.

In some embodiments, an apparatus comprising: one or more computer processors; and a non-transitory computer-readable storage medium comprising instructions, that when executed, control the one or more computer processors to be operable for: receiving a request for an advertisement during delivery of content to a client device; selecting a first advertisement deal from a first grouping of advertisement deals based on a first parameter value for the first advertisement deal; determining a second parameter value for advertisement deals in the first grouping of advertisement deals; comparing the second parameter value of the advertisement deals in the first grouping of advertisement deals to a second parameter value of a set of second advertisement deals from a second grouping of advertisement deals; selecting one of a first category of the first grouping of advertisement deals and a second category of the second grouping of advertisement deals; and selecting, for the request, a first advertisement deal from the first grouping of advertisement deals when the first category of the first grouping of advertisement deals is selected and a second advertisement deal when the second category of the second grouping of advertisement deals is selected.

### System

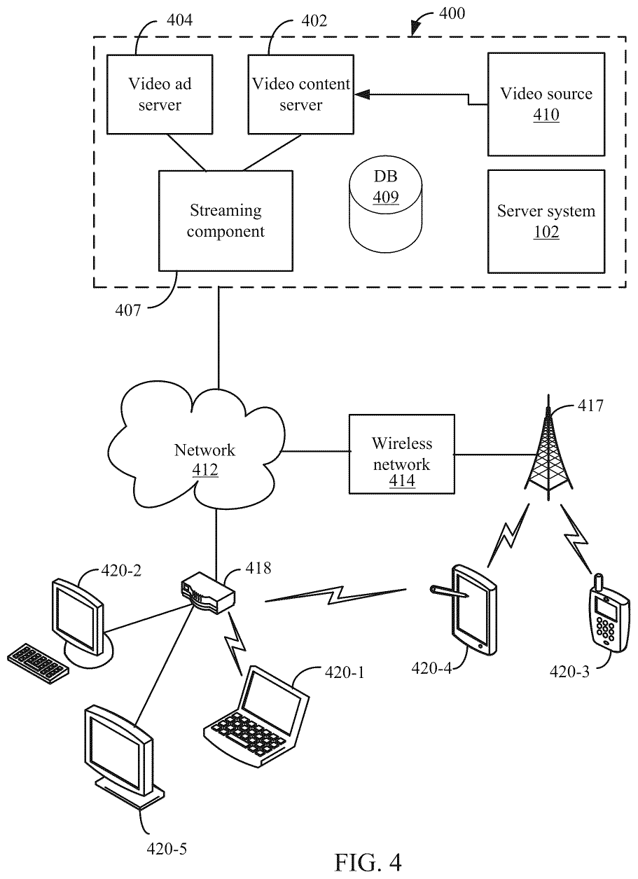

Features and aspects as disclosed herein may be implemented in conjunction with a video streaming system 400 in communication with multiple client devices via one or more communication networks as shown in FIG. 4. Aspects of the video streaming system 400 are described merely to provide an example of an application for enabling distribution and delivery of content prepared according to the present disclosure. It should be appreciated that the present technology is not limited to streaming video applications and may be adapted for other applications and delivery mechanisms.

In one embodiment, a media program provider may include a library of media programs. For example, the media programs may be aggregated and provided through a site (e.g., website), application, or browser. A user can access the media program provider's site or application and request media programs. The user may be limited to requesting only media programs offered by the media program provider.

In system 400, video data may be obtained from one or more sources for example, from a video source 410, for use as input to a video content server 402. The input video data may comprise raw or edited frame-based video data in any suitable digital format, for example, Moving Pictures Experts Group (MPEG)-1, MPEG-2, MPEG-4, VC-1, H.264/Advanced Video Coding (AVC), High Efficiency Video Coding (HEVC), or other format. In an alternative, a video may be provided in a non-digital format and converted to digital format using a scanner and/or transcoder. The input video data may comprise video clips or programs of various types, for example, television episodes, motion pictures, and other content produced as primary content of interest to consumers. The video data may also include audio or only audio may be used.

The video streaming system 400 may include one or more computer servers or modules 402, 404, and/or 407 distributed over one or more computers. Each server 402, 404, 407 may include, or may be operatively coupled to, one or more data stores 409, for example databases, indexes, files, or other data structures. A video content server 402 may access a data store (not shown) of various video segments. The video content server 402 may serve the video segments as directed by a user interface controller communicating with a client device. As used herein, a video segment refers to a definite portion of frame-based video data, such as may be used in a streaming video session to view a television episode, motion picture, recorded live performance, or other video content.

In some embodiments, a video advertising server 404 may access a data store of relatively short videos (e.g., 10 second, 30 second, or 60 second video advertisements) configured as advertising for a particular advertiser or message. The advertising may be provided for an advertiser in exchange for payment of some kind or may comprise a promotional message for the system 400, a public service message, or some other information. The video advertising server 404 may serve the video advertising segments as directed by a user interface controller (not shown).

The video streaming system 400 also may include server system 102

The video streaming system 400 may further include an integration and streaming component 407 that integrates video content and video advertising into a streaming video segment. For example, streaming component 407 may be a content server or streaming media server. A controller (not shown) may determine the selection or configuration of advertising in the streaming video based on any suitable algorithm or process. The video streaming system 400 may include other modules or units not depicted in FIG. 4, for example, administrative servers, commerce servers, network infrastructure, advertising selection engines, and so forth.

The video streaming system 400 may connect to a data communication network 412. A data communication network 412 may comprise a local area network (LAN), a wide area network (WAN), for example, the Internet, a telephone network, a wireless cellular telecommunications network (WCS) 414, or some combination of these or similar networks.

One or more client devices 420 may be in communication with the video streaming system 400, via the data communication network 412, wireless cellular telecommunications network 414, and/or another network. Such client devices may include, for example, one or more laptop computers 420-1, desktop computers 420-2, “smart” mobile phones 420-3, tablet devices 420-4, network-enabled televisions 420-5, or combinations thereof, via a router 418 for a LAN, via a base station 417 for a wireless cellular telecommunications network 414, or via some other connection. In operation, such client devices 420 may send and receive data or instructions to the system 400, in response to user input received from user input devices or other input. In response, the system 400 may serve video segments and metadata from the data store 409 responsive to selection of media programs to the client devices 420. Client devices 420 may output the video content from the streaming video segment in a media player using a display screen, projector, or other video output device, and receive user input for interacting with the video content.

Distribution of audio-video data may be implemented from streaming component 407 to remote client devices over computer networks, telecommunications networks, and combinations of such networks, using various methods, for example streaming. In streaming, a content server streams audio-video data continuously to a media player component operating at least partly on the client device, which may play the audio-video data concurrently with receiving the streaming data from the server. Although streaming is discussed, other methods of delivery may be used. The media player component may initiate play of the video data immediately after receiving an initial portion of the data from the content provider. Traditional streaming techniques use a single provider delivering a stream of data to a set of end users. High bandwidth and processing power may be required to deliver a single stream to a large audience, and the required bandwidth of the provider may increase as the number of end users increases.

Streaming media can be delivered on-demand or live. Streaming enables immediate playback at any point within the file. End-users may skip through the media file to start playback or change playback to any point in the media file. Hence, the end-user does not need to wait for the file to progressively download. Typically, streaming media is delivered from a few dedicated servers having high bandwidth capabilities via a specialized device that accepts requests for video files, and with information about the format, bandwidth and structure of those files, delivers just the amount of data necessary to play the video, at the rate needed to play it. Streaming media servers may also account for the transmission bandwidth and capabilities of the media player on the destination client. Streaming component 407 may communicate with client device 420 using control messages and data messages to adjust to changing network conditions as the video is played. These control messages can include commands for enabling control functions such as fast forward, fast reverse, pausing, or seeking to a particular part of the file at the client.

Since streaming component 407 transmits video data only as needed and at the rate that is needed, precise control over the number of streams served can be maintained. The viewer will not be able to view high data rate videos over a lower data rate transmission medium. However, streaming media servers (1) provide users random access to the video file, (2) allow monitoring of who is viewing what video programs and how long they are watched (3) use transmission bandwidth more efficiently, since only the amount of data required to support the viewing experience is transmitted, and (4) the video file is not stored in the viewer's computer, but discarded by the media player, thus allowing more control over the content.

Streaming component 407 may use TCP-based protocols, such as HTTP and Real Time Messaging Protocol (RTMP). Streaming component 407 can also deliver live webcasts and can multicast, which allows more than one client to tune into a single stream, thus saving bandwidth. Streaming media players may not rely on buffering the whole video to provide random access to any point in the media program. Instead, this is accomplished through the use of control messages transmitted from the media player to the streaming media server. Other protocols used for streaming are Hypertext Transfer Protocol (HTTP) live streaming (HLS) or Dynamic Adaptive Streaming over HTTP (DASH). The HLS and DASH protocols deliver video over HTTP via a playlist of small segments that are made available in a variety of bitrates typically from one or more content delivery networks (CDNs). This allows a media player to switch both bitrates and content sources on a segment-by-segment basis. The switching helps compensate for network bandwidth variances and also infrastructure failures that may occur during playback of the video.

The delivery of video content by streaming may be accomplished under a variety of models. In one model, the user pays for the viewing of video programs, for example, paying a fee for access to the library of media programs or a portion of restricted media programs, or using a pay-per-view service. In another model widely adopted by broadcast television shortly after its inception, sponsors pay for the presentation of the media program in exchange for the right to present advertisements during or adjacent to the presentation of the program. In some models, advertisements are inserted at predetermined times in a video program, which times may be referred to as “ad slots” or “ad breaks.” With streaming video, the media player may be configured so that the client device cannot play the video without also playing predetermined advertisements during the designated ad slots.

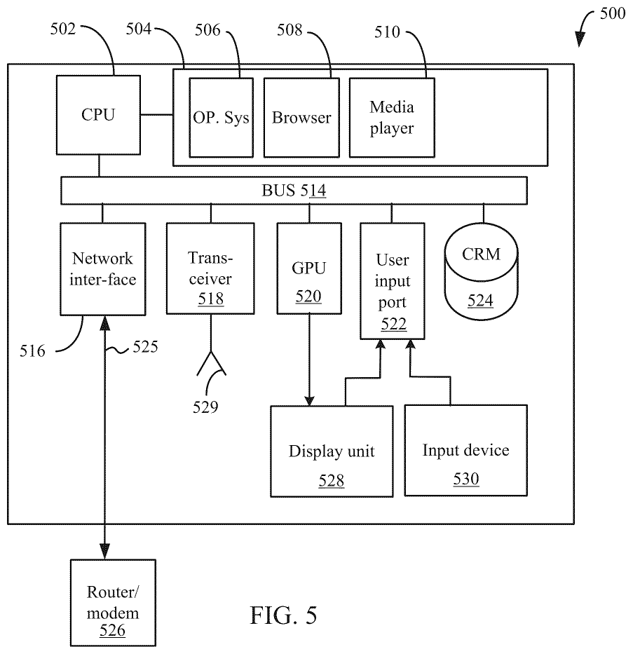

Referring to FIG. 5, a diagrammatic view of an apparatus 500 for viewing video content and advertisements is illustrated. In selected embodiments, the apparatus 500 may include a processor (CPU) 502 operatively coupled to a processor memory 504, which holds binary-coded functional modules for execution by the processor 502. Such functional modules may include an operating system 506 for handling system functions such as input/output and memory access, a browser 508 to display web pages, and media player 510 for playing video. The memory 504 may hold additional modules not shown in FIG. 5, for example modules for performing other operations described elsewhere herein.

A bus 514 or other communication component may support communication of information within the apparatus 500. The processor 502 may be a specialized or dedicated microprocessor configured or operable to perform particular tasks in accordance with the features and aspects disclosed herein by executing machine-readable software code defining the particular tasks. Processor memory 504 (e.g., random access memory (RAM) or other dynamic storage device) may be connected to the bus 514 or directly to the processor 502, and store information and instructions to be executed by a processor 502. The memory 504 may also store temporary parameters or other intermediate information during execution of such instructions.

A computer-readable medium in a storage device 524 may be connected to the bus 514 and store static information and instructions for the processor 502; for example, the storage device (CRM) 524 may store the modules 506, 508, 510 and 512 when the apparatus 500 is powered off, from which the modules may be loaded into the processor memory 504 when the apparatus 500 is powered up. The storage device 524 may include a non-transitory computer-readable storage medium holding information, instructions, or some combination thereof, for example instructions that when executed by the processor 502, cause the apparatus 500 to be configured or operable to perform one or more operations of a method as described herein.

A communication interface 516 may also be connected to the bus 514. The communication interface 516 may provide or support two-way data communication between the apparatus 500 and one or more external devices, e.g., the streaming system 400, optionally via a router/modem 526 and a wired or wireless connection. In the alternative, or in addition, the apparatus 500 may include a transceiver 518 connected to an antenna 529, through which the apparatus 500 may communicate wirelessly with a base station for a wireless communication system or with the router/modem 526. In the alternative, the apparatus 500 may communicate with a video streaming system 400 via a local area network, virtual private network, or other network. In another alternative, the apparatus 500 may be incorporated as a module or component of the system 400 and communicate with other components via the bus 514 or by some other modality.

The apparatus 500 may be connected (e.g., via the bus 514 and graphics processing unit 520) to a display unit 528. A display 528 may include any suitable configuration for displaying information to an operator of the apparatus 500. For example, a display 528 may include or utilize a liquid crystal display (LCD), touchscreen LCD (e.g., capacitive display), light emitting diode (LED) display, projector, or other display device to present information to a user of the apparatus 500 in a visual display.

One or more input devices 530 (e.g., an alphanumeric keyboard, microphone, keypad, remote controller, game controller, camera or camera array) may be connected to the bus 514 via a user input port 522 to communicate information and commands to the apparatus 500. In selected embodiments, an input device 530 may provide or support control over the positioning of a cursor. Such a cursor control device, also called a pointing device, may be configured as a mouse, a trackball, a track pad, touch screen, cursor direction keys or other device for receiving or tracking physical movement and translating the movement into electrical signals indicating cursor movement. The cursor control device may be incorporated into the display unit 528, for example using a touch sensitive screen. A cursor control device may communicate direction information and command selections to the processor 502 and control cursor movement on the display 528. A cursor control device may have two or more degrees of freedom, for example allowing the device to specify cursor positions in a plane or three-dimensional space.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

1. An apparatus comprising:
storage for storing a first parameter that controls selection between guaranteed deals and non-guaranteed deals and a second parameter that controls selection between guaranteed deals, and not with the non-guaranteed deals, wherein the guaranteed deals and non-guaranteed deals are associated with secondary content that is inserted during playback of primary content;
a controller configured to use feedback from selection of secondary content that is associated with guaranteed deals being delivered to individually update the first parameter or the second parameter for one or more guaranteed deals based on a delivery number and a delivery speed of a guaranteed deal compared to an expected delivery pattern;
a selector configured to:
select a guaranteed deal from a group of guaranteed deals based on the second parameter for guaranteed deals in the group of guaranteed deals;
compare a first value that represents respective values of the first parameter for guaranteed deals in the group of guaranteed deals and a second value that represents respective values of the first parameter for a group of non-guaranteed deals to select one of the group of guaranteed deals or the group of non-guaranteed deals; and
select secondary content for the guaranteed deal when the group of guaranteed deals is selected and select secondary content for a non-guaranteed deal when the group of non-guaranteed deals is selected, wherein the secondary content is selected for delivery during a break in the primary content.

2-20. (canceled)

21. The apparatus of claim 1, wherein the selector:
receives a request for secondary content for the break during playback of the primary content; and
sends information for the secondary content in response to the request to cause delivery of the secondary content.

22. The apparatus of claim 21, wherein the updater:
receives feedback from a display of the secondary content;
uses the feedback to update the delivery number and the delivery speed of the guaranteed deal; and
updates the first parameter or the second parameter based on the delivery number and the delivery speed that is updated.

23. The apparatus of claim 1, wherein the delivery pattern is a set pacing of the delivery speed to deliver the secondary content over a time period.

24. The apparatus of claim 23, wherein the guaranteed deal guarantees the delivery number of secondary content is delivered over the time period.

25. The apparatus of claim 24, wherein the non-guaranteed deals do not include requirements for the delivery number or delivery speed in the delivery pattern.

26. The apparatus of claim 1, wherein the selector:
selects the guaranteed deal based on a weighted random selection of guaranteed deals in the group of guaranteed deals, wherein the weights are based on the second parameter associated with guaranteed deals.

27. The apparatus of claim 26, wherein the guaranteed deal that is selected does not have a highest value for the second parameter.

28. The apparatus of claim 1, wherein the updater:
compares the delivery speed to the expected delivery pattern;
increases the second parameter when the delivery number and the delivery speed of the guaranteed deal is behind the expected delivery pattern; and
decreases the second parameter when the delivery number and the delivery speed of the guaranteed deal is ahead of the expected delivery pattern.

29. The apparatus of claim 1, further comprising an updater:
initializes the first parameter for the guaranteed deals to a first initial value;
initializes the second parameter for the guaranteed deals to a second initial value; and
initializes the second parameter for the non-guaranteed deals to a third initial value based on values from the non-guaranteed deals in the group of non-guaranteed deals.

30. The apparatus of claim 29, wherein:
the second initial value for the guaranteed deals is based on the delivery pattern for respective guaranteed deals, and
the third initial value for the non-guaranteed deals is based on an average of values for the second parameter of the group of non-guaranteed deals.

31. The apparatus of claim 1, wherein the selector:
determines values for the first parameter for the group of guaranteed deals;
determines values for the first parameter for the group of non-guaranteed deals;
selects the first value for the first parameter for the group of guaranteed deals and the second value for the first parameter for the group of non-guaranteed deals; and
selects the group of guaranteed deals or the group of non-guaranteed deals based on the first value and the second value.

32. The apparatus of claim 1, wherein the updater:
determines a risk of not meeting the expected delivery pattern for the group of guaranteed deals; and
sets the first value to a higher value that is above the values for the first parameter of the group of guaranteed deals.

33. The apparatus of claim 32, wherein the updater:
does not determine the risk of not meeting the expected delivery pattern for the group of guaranteed deals; and
sets the first value to a maximum value found in the values for the first parameter of the group of guaranteed deals.

34. The apparatus of claim 1, wherein:
the second value is based on a maximum value found in the values for first parameter of the group of non-guaranteed deals.

35. The apparatus of claim 34, wherein the selector:
selects the guaranteed deal that does not have a highest value for the first parameter or the second parameter among the group of guaranteed deals.

36. The apparatus of claim 1, wherein:
a guaranteed deal with a delivery goal smaller than other delivery goals and a higher first parameter or a higher second parameter in the group of guaranteed deals is not selected.

37. The apparatus of claim 1, further comprising:
a server that delivers the secondary content to a client device during the break.

38. A non-transitory computer-readable storage medium containing instructions, that when executed, control a computer system to be operable for:
storing a first parameter that controls selection between guaranteed deals and non-guaranteed deals and a second parameter that controls selection between guaranteed deals, and not with the non-guaranteed deals, wherein the guaranteed deals and non-guaranteed deals are associated with secondary content that is inserted during playback of primary content;
using feedback from selection of secondary content that is associated with guaranteed deals being delivered to individually update the first parameter or the second parameter for one or more guaranteed deals based on a delivery number and a delivery speed of a guaranteed deal compared to an expected delivery pattern;
selecting a guaranteed deal from a group of guaranteed deals based on the second parameter for guaranteed deals in the group of guaranteed deals;
comparing a first value that represents respective values of the first parameter for guaranteed deals in the group of guaranteed deals and a second value that represents respective values of the first parameter for a group of non-guaranteed deals to select one of the group of guaranteed deals or the group of non-guaranteed deals; and
selecting secondary content for the guaranteed deal when the group of guaranteed deals is selected and select secondary content for a non-guaranteed deal when the group of non-guaranteed deals is selected, wherein the secondary content is selected for delivery during a break in the primary content.

39. A method comprising:
storing a first parameter that controls selection between guaranteed deals and non-guaranteed deals and a second parameter that controls selection between guaranteed deals, and not with the non-guaranteed deals, wherein the guaranteed deals and non-guaranteed deals are associated with secondary content that is inserted during playback of primary content;
using feedback from selection of secondary content that is associated with guaranteed deals being delivered to individually update the first parameter or the second parameter for one or more guaranteed deals based on a delivery number and a delivery speed of a guaranteed deal compared to an expected delivery pattern;
selecting a guaranteed deal from a group of guaranteed deals based on the second parameter for guaranteed deals in the group of guaranteed deals;
comparing a first value that represents respective values of the first parameter for guaranteed deals in the group of guaranteed deals and a second value that represents respective values of the first parameter for a group of non-guaranteed deals to select one of the group of guaranteed deals or the group of non-guaranteed deals; and
selecting secondary content for the guaranteed deal when the group of guaranteed deals is selected and select secondary content for a non-guaranteed deal when the group of non-guaranteed deals is selected, wherein the secondary content is selected for delivery during a break in the primary content.
